(19) United States
(12) Patent Application Publication
(10) Pub. No.: US 2017/0256012 A1
(43) Pub. Date: Sep. 7, 2017

(54) DRIVER CONTRACTING SYSTEM AND METHOD

(71) Applicants: Alen Buzalja, Chicago, IL (US); Ilija Soc, Chicago, IL (US)

(72) Inventors: Alen Buzalja, Chicago, IL (US); Ilija Soc, Chicago, IL (US)

(21) Appl. No.: 15/057,237

(22) Filed: Mar. 1, 2016

(51) Int. Cl. G06Q 50/18; G06Q 30/08; G06Q 30/06; G06Q 50/30

(52) U.S. Cl. CPC G06Q 50/188; G06Q 50/30; G06Q 30/08; G06Q 30/0611

(57) ABSTRACT

A driver contracting system is provided to facilitate contracting between parties for driver services. The driver contracting system may include a computerized device, database, requestor interface, contractor interface, first vehicle, second vehicle, recording module, music selection module, commercial platform module, dimension validation module, hook-up configuration, and pricing module. A method to facilitate contracting between parties for driver services using the driver contracting system is also provided. The contractor may travel to a requestor via first vehicle. To fulfill a bid contract, the contractor may transport the requestor and a second vehicle associated with the requestor to a destination.

### FIELD OF THE INVENTION

The present disclosure relates to a system to facilitate contracting for a service. More particularly, the disclosure relates to facilitating contracting between parties for driver services.

### BACKGROUND

Throughout history, people have sought to improve ways to move from one location to another. This push has led to the development of horse drawn carriages, sea vessels, railroads, and the automobile. Adoption of the car and other automobiles provided previously unseen levels of mobility, convenience, and independence.

As the popularity of the automobile increased, so did the need to ensure safe operation of these machines and protect other members of society. Road traffic accidents quickly became a leading cause of injury-related deaths. Regulations were enacted to ensure safe operation of automobiles. These regulations can reduce injuries from unsafe driving practices such as driving while intoxicated or distracted.

Public transportation, taxicabs, and other vehicles for hire can help transport passengers that are unable to safely or legally pilot their own automobiles. For example, a prudent person who is too intoxicated to safely operate his or her vehicle may request a taxi or other service to safely get home. However, this person must still make a second trip later to retrieve his or her vehicle, resulting in an added inconvenience and possible expense. By reducing this inconvenience, more people that might choose to unsafely pilot their own vehicles may instead choose to contract a safe driver. This safe driver may return the requesting person and their vehicle to a chosen destination, such as their home.

Therefore, a need exists to solve the deficiencies present in the prior art. What is needed is a system to facilitate contracting for driver services, which may transport a person with his or her own vehicle. What is needed is an interface usable by a requestor to seek a contractor. What is needed is an interface usable by a contractor to accept bids from a requestor. What is needed is a driver service utilizing a first vehicle transportable with a second vehicle.

### SUMMARY

An aspect of the disclosure advantageously provides a system to facilitate contracting for driver services, which may transport a person with his or her own vehicle. An aspect of the disclosure advantageously provides an interface usable by a requestor to seek a contractor. An aspect of the disclosure advantageously provides an interface usable by a contractor to accept bids from a requestor. An aspect of the disclosure advantageously provides a driver service utilizing a first vehicle transportable with a second vehicle.

Accordingly, the disclosure may feature a system operable on a computerized device with a processor and memory including a database, a requestor component, and a contractor component. The database may be accessible via a network. The database may include information for a bid, a requestor, and a contractor. The bid may be creatable by the requestor and the bid may be selectively accepted by the contractor. The requestor component may be communicably connected to the database. The bid may be created via the requestor component. The requestor component may include requestor modules to provide at least part of the information associated with the bid. The contractor component may be communicably connected to the database. The bid may be acceptable via the contractor component. The contractor component may include contractor modules to access at least part of the information by the contractor associated with the bid. The bid may be accepted via the steps: a) communicating the bid to the database by the requestor for acceptance by the contractor, the bid including at least part of the information provided by at least part of the requestor modules, b) viewing the bid by the contractor, c) provisionally accepting the bid by the contractor, d) traveling by the contractor to the requestor via a first vehicle, e) transporting the requestor, the first vehicle, and a second vehicle associated with the requestor to a destination by the contractor, and f) fulfilling the bid to receive payment.

In another aspect, the first vehicle may be storable at least partially within the second vehicle for transportation by the contractor.

In another aspect, the first vehicle may include at least two wheels. At least one of the wheels may be driven by a motorized source of propulsion.

In another aspect, the first vehicle may be at least partially collapsible.

In another aspect, the bid may include a condition. The bid may be acceptable only by the contractor meeting the condition.

In another aspect, the first vehicle may include a hook-up mechanism. Transporting the second vehicle may include reversibly hooking up to the first vehicle via the hook-up mechanism. The bid may include an indication that having a hook-up mechanism is included by the condition.

In another aspect, the second vehicle may be passively transported via the hook-up mechanism of the first vehicle to the destination.

In another aspect, the requestor modules may include a media module through which media is selectable to be played as at least part of the bid is fulfilled.

In another aspect, a recorder module may be included that is capable of recording at least part of the bid being fulfilled.

In another aspect, the contractor component may include an interface with a map. The bid may be acceptable from the interface.

In another aspect, the bid may include the destination. The destination may be included in the information viewable to the contractor.

In another aspect, a commercial platform may be included through which the requestor can perform commercial transactions associated with fulfillment of the bid. The commercial transactions performed through the commercial platform may be at least partially monetized by the system.

In another aspect, the database may be storable on a server accessible by at least the requestor component and the contractor component via the network.

According to an embodiment of this disclosure, a system operable on a computerized device with a processor and memory is provided including a database, a requestor component, and a contractor component. The database may be accessible via a network. The requestor component may include information for a bid, a requestor, and a contractor. The bid may be creatable by the requestor and the bid being selectively accepted by the contractor. The requestor component may be communicably connected to the database through which the bid is created. The requestor component may include requestor modules to provide at least part of the information associated with the bid. The contractor component may be communicably connected to the database through which the bid is acceptable. The contractor component may include contractor modules to access at least part of the information associated with the bid by the contractor. The bid may be accepted via the steps: a) communicating the bid to the database by the requestor for acceptance by the contractor, the bid including at least part of the information provided by at least part of the requestor modules, b) viewing the bid by the contractor, c) provisionally accepting the bid by the contractor, d) traveling by the contractor to the requestor via a first vehicle, e) storing the first vehicle at least partially within a second vehicle associated with the requestor, f) transporting the requestor, the first vehicle, and the second vehicle to a destination by the contractor, g) removing the first vehicle from the second vehicle, and h) fulfilling the bid. The bid may include a condition, the bid being acceptable only by the contractor meeting the condition.

In another aspect, the first vehicle may be at least partially collapsible.

In another aspect, the system may further include a media module, a recorder module, and a commercial platform. The media module may allow media to be selectable to be played via the second vehicle as at least part of the bid is fulfilled. The recorder module may be capable of recording at least part of the bid being fulfilled. The commercial platform may allow the requestor to perform commercial transactions associated with fulfillment of the bid. The commercial transactions performed through the commercial platform may be at least partially monetized by the system.

According to an embodiment of this disclosure, a method is provided for matching a requestor with a contractor via a system including a processor and memory. The method may include the steps: a) communicating a bid by the requestor to a database via a requestor component for acceptance by the contractor, the database being accessible via a network and comprising information for the bid, the requestor, and the contractor; b) viewing the bid by the contractor via a contractor component, the bid including at least part of the information provided by the requestor; c) provisionally accepting the bid by the contractor via the contractor component; d) traveling by the contractor to the requestor via a first vehicle; e) transporting the requestor, the first vehicle, and a second vehicle associated with the requestor to a destination by the contractor; and f) fulfilling the bid to receive payment. The bid may be creatable by the requestor. The bid may include a condition. The bid may be selectively accepted by the contractor meeting the condition. The requestor component and the contractor component may be communicably connected to the database. The requestor component may include requestor modules to provide at least part of the information associated with the bid. The contractor component may include contractor modules to access at least part of the information associated with the bid by the contractor.

In another aspect, the method may include after step (d), step (g) storing the first vehicle at least partially within the second vehicle. The method may include after step (e), step (h) removing the first vehicle from the second vehicle.

In another aspect, the method may include after step (d), step (i) reversibly connecting the second vehicle to a hook-up mechanism of the first vehicle. The method may include after step (e), step (j) disconnecting the second vehicle from the hook-up mechanism.

In another aspect, the system may include a media module, a recorder module, and a commercial platform module. The media module may allow media to be selectable to be played via the second vehicle as at least part of the bid is fulfilled. The recorder module may be capable of recording at least part of the bid being fulfilled. The commercial platform may allow the requestor to perform commercial transactions associated with fulfillment of the bid, the commercial transactions performed through the commercial platform being at least partially monetized by the system.

Terms and expressions used throughout this disclosure are to be interpreted broadly. Terms are intended to be understood respective to the definitions provided by this specification. Technical dictionaries and common meanings understood within the applicable art are intended to supplement these definitions. In instances where no suitable definition can be determined from the specification or technical dictionaries, such terms should be understood according to their plain and common meaning. However, any definitions provided by the specification will govern above all other sources.

Various objects, features, aspects, and advantages of the disclosure described by this disclosure will become more apparent from the following detailed description, along with the accompanying drawings in which like numerals represent like components.

### BRIEF DESCRIPTION OF THE DRAWINGS

FIG. 1 is a block diagram view of an Illustrative driver contracting system, according to an embodiment of this disclosure.

FIG. 2 is a block diagram view of an Illustrative computerized device, according to an embodiment of this disclosure.

FIG. 3 is a diagram view of an interface for a requestor component, according to an embodiment of this disclosure.

FIG. 4 is a diagram view of an interface for a requestor component to define a bid, according to an embodiment of this disclosure.

FIG. 5 is a diagram view of an interface for a contractor component, according to an embodiment of this disclosure.

FIG. 6 is a block diagram view of a recording module, according to an embodiment of this disclosure.

FIG. 7 is a flowchart view of a requestor creating a bid, according to an embodiment of this disclosure.

FIG. 8 is a flowchart view of a contractor provisionally accepting a bid, according to an embodiment of this disclosure.

FIG. 9 is a flowchart view of a contractor traveling to a requestor to fulfill the bid, according to an embodiment of this disclosure.

FIG. 10 is a flowchart view of storing a first vehicle at least partially with a second vehicle, according to an embodiment of this disclosure.

FIG. 11 is a flowchart view of an alternative embodiment including use of a hook-up mechanism, according to an embodiment of this disclosure.

FIG. 12 is a block diagram view of a commercial platform usable with the service, according to an embodiment of this disclosure.

### DETAILED DESCRIPTION

The following disclosure is provided to describe various embodiments of a driver contracting system. Skilled artisans will appreciate additional embodiments and uses of the present invention that extend beyond the examples of this disclosure. Terms included by any claim are to be interpreted as defined within this disclosure. Singular forms should be read to contemplate and disclose plural alternatives. Similarly, plural forms should be read to contemplate and disclose singular alternatives. Conjunctions should be read as inclusive except where stated otherwise.

Expressions such as “at least one of A, B, and C” should be read to permit any of A, B, or C singularly or in combination with the remaining elements. Additionally, such groups may include multiple instances of one or more element in that group, which may be included with other elements of the group. All numbers, measurements, and values are given as approximations unless expressly stated otherwise.

Various aspects of the present disclosure will now be described in detail, without limitation. In the following disclosure, a driver contracting system will be discussed. Those of skill in the art will appreciate alternative labeling of the driver contracting system as a driver matching system, contractor bidding method, ride-sharing system, requestor-contractor matching system, matching system, the invention, or other similar names. Similarly, those of skill in the art will appreciate alternative labeling of using the driver contracting system as a method for defining a bid, contractor bidding method, driver bidding method, ride-share bidding method, method, operation, the invention, or other similar names. Skilled readers should not view the inclusion of any alternative labels as limiting in any way.

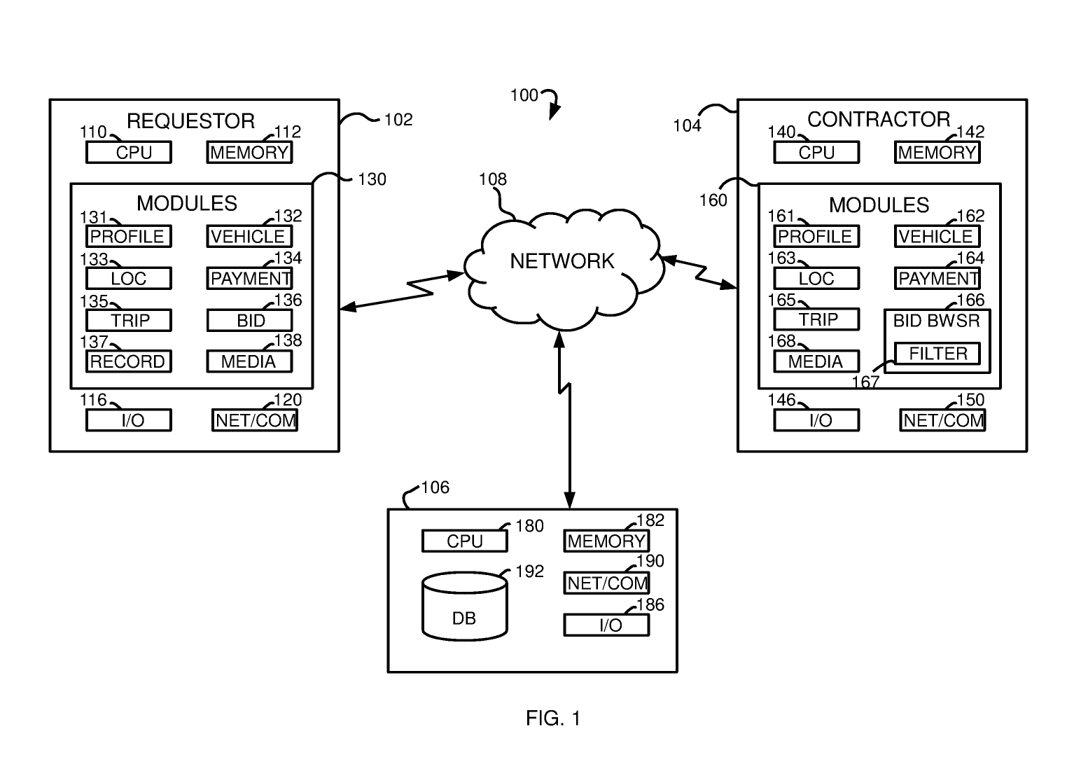

Referring to FIGS. 1-12, the driver contracting system will now be discussed in more detail. The driver contracting system may include one or more computerized device, database, requestor component, contractor component, first vehicle, second vehicle, recording module, media module, commercial platform module, additional modules, hook-up indication, payment module, pricing module, and additional components that will be discussed in greater detail below.

One or more of these modules may be included by the requestor component, the contractor component, a server, and/or another device. The components of the system may be communicably connected via a network. The driver contracting system may operate one or more of these components interactively with other components to facilitate contracting between parties for driver services and/or other services.

Throughout this disclosure, a bid will be discussed in the context as a request for a contractor to engage services with a requestor. Various components of the system may be interacted with to create, view, and/or select a bid. For example, a prospective passenger may desire to engage the services of a contracted driver to pilot the passenger's vehicle to a destination. The requestor may create a bid requesting a contracted service. The bid may include information about the requested service, for example vehicle type, origin, destination, time of trip, and other information that could be useful by a contractor in determining whether to accept the bid. The contractor, for example, a driver, may browse one or more bids to select a suitable bid that he or she wishes to accept. The contractor may optionally filter possible bids to narrow down a prospective bid that meets the contractor's criteria.

Throughout this disclosure, a first vehicle and a second vehicle will be discussed in regard to fulfillment of a bid. The first vehicle and second vehicle may be operated by the contractor, requestor, and/or a third party. In one example, the first vehicle may be operated by a contractor to travel to an origin of a bid. The first vehicle may be owned by the contractor and/or another party. The second vehicle may be operated by the contractor in fulfillment of the bid. The second vehicle may be owned by the requestor and/or another party. In one embodiment, the first vehicle may fit at least partially within the second vehicle. In an alternative embodiment, the second vehicle may be selectively hooked-up to the first vehicle. The relationship between the first vehicle and the second vehicle will be discussed in more detail throughout this disclosure.

Referring now to FIG. 1, a block diagram 100 of an illustrative driver contracting system will be discussed, without limitation. The system may include one or more requestor components 102, contractor component 104, server 106, database 192, and/or other components. The components of the system may be communicably connected via a network 108, for example and without limitation, the Internet.

The requestor component will now be discussed in more detail. The requestor component 102 may include features implemented in hardware and/or software. For example, the requestor component 102 may include a processor 110 and memory 112 capable of executing computer coded instructions. The requestor component 102 may additionally include an input/output (I/O) connection 116 to interface with additional component. Furthermore, the requestor component 102 may include a network communications interface 120, through which the features of the requestor component 102 may communicate with additional devices accessible via a network 108.

The requestor component 102 may include requestor modules 130. The requestor modules 130 may operate via software commands, hardware-implemented logic, in association with sensors, using a combination of hardware and software features, and/or using additional features that would be apparent to a person of skill in the art after having the benefit of this disclosure.

The requestor modules 130 may sense, gather, report, and/or otherwise provide information usable to create a bid. This information may be stored in a database, which may be a local database via the requestor module and/or communicably connected database 192 accessible via a network 108. In one example, the database 192 may be included by a server 106 communicably connected via the network 108.

A selection of illustrative requestor modules 130 will now be provided to demonstrate some features and capabilities of a requestor module. Information captured and/or provided by requestor modules 130 is storable locally by the individual module, by the requestor component 102, and/or in a connected database 192. In embodiments where at least part of the information is stored in a network accessible database 192, at least part of the information may be accessible via the network 108 to other connected devices of the system.

The requestor modules 130 may include a requestor profile module 131. An illustrative requestor profile module 131 may include information about a requestor. Possible information may include name, age, background information, home address, transaction history, rating, peers, and/or other information that could be used to describe the requestor. Skilled artisans will appreciate additional types of information that may be related to the requestor, and therefore may be included by the requestor profile module 131, after having the benefit of this disclosure.

The requestor modules 130 may include a requestor vehicle module 132. An illustrative requestor vehicle module 132 may include information about one or more vehicles commonly operated by the requestor. Vehicles with information provided by the requestor vehicle module 132 may include vehicles owned by the requestor, frequently used by the requestor, and/or otherwise associated with the requestor. Vehicles included by the requestor vehicle module 132 may be a second vehicle. The requestor vehicle module 132 may include additional information accommodation and/or compatibility with a first vehicle that would be operated by a contractor. Details may be stored relating to each vehicle included by the requestor vehicle module 132, for example, make, model, year, interior volume, storage capacity, accommodation for a first vehicle, seats, articles present within the vehicle, accessibility considerations, mechanical information, maintenance information, insurance information, and/or other details that would be apparent to a skilled artisan after having the benefit of this disclosure.

The requestor modules 130 may include a requestor location module 133. An illustrative requestor location module 133 may include information about a requestor's current location, desired destination, home location, user-defined location, location history, and other locations that may be useful in defining and/or acceptance of a bid. In one embodiment, the requestor location module 133 may use sensors and or other computerized components to assist in determining a location. Illustrative sensors may include global positioning sensors (GPS), antenna useful for triangulation of cellular or other wireless signals, internet access point or network recognition tools, and/or other location sensing features that would be apparent to a person of skill in the art after having the benefit of this disclosure.

The requestor modules 130 may include a requestor payment module 134. An illustrative requestor payment module 134 may include information regarding payment for fulfillment of the bid. Examples of payment methods may include connections to a bank account, credit card, deposit account, reward points, gift points, credits, cash, other forms of currency, and/or other forms of payment or compensation that would be apparent to skilled artisans. Stored payment methods may be retrieved via the requestor payment module 134 to automatically pay a contractor after completion of the bid. The requestor payment module 134 may additionally be used to pay access, usage, and/or other fees associable with using the system. Stored payment methods may also be optionally accessible to cover incidentals and/or damages incurred during fulfillment of the bid.

The requestor modules 130 may include a requestor trip module 135. An illustrative requestor trip module 135 may include information regarding a trip to be requested via a bid. For example, the requestor trip module 135 may include information about commonly requested trips, such as a trip to the requestor's home. In another example, a requestor trip module 135 may include information for recommended trips, such as to a late night restaurant or a suggested location of interest. Optionally, some locations of interest may be sponsored by third parties or advertisers. Recommended trip and sponsored content may be provided at least partially via a commercial module included with the system.

The requestor modules 130 may include a requestor bid module 136. An illustrative requestor bid module 136 may include tools to define and create a bid. The tools of the requestor bid module 136 may operate with other requestor modules 130 of the requestor component 102 to provide information includable in a bid. For example, the requestor bid module 136 may access information about the requestor via the requestor profile module 131, access information about a vehicle via the requestor vehicle module 132, and predict a trip via information provided by the requestor trip module 133. The information provided by requestor modules 130 may be used to suggest entries to the fields used to create a bid. In one embodiment, a requestor interface may be manipulated to define a bid using the requestor bid module 136.

The requestor modules 130 may include a requestor recording module 137. An illustrative requestor recording module 137 may permit recording of at least part a bid being fulfilled. The requestor recording module 137 may operate with sensors and other aspects of the requestor component. For example, the requestor recording module 137 may operate a camera and/or microphone connected to the requestor component 102 via its I/O connections 116. In an alternative embodiment, the requestor recording module 137 may remotely operate a camera or other recording device communicably connected to the system.

Using the requestor recording module 137, the system may advantageously allow parties associated with fulfillment of a bid to record at least part of the fulfillment of the bid. For example, the requestor recording module 137 may allow users to record a trip from start to end. In an illustrative application, provided in the interest of clarity and without limitation, cameras usable with the requestor recording module 137 may be located on the contractor's device, uniform, clothing, or within the vehicle being operated by the contractor. Aspects of a recording could be selectively disabled, for example, to allow recording of video without sound, sound without video, or another combination of recorded information that would be apparent to a person of skill in the art.

The requestor modules 130 may include a requestor media module 138. An illustrative requestor media module 138 may allow a requestor and/or contractor to select a type of media for playback during fulfillment of a bid. For example, a requestor may operate the requestor media module 138 to select a song for playback through the speakers of the vehicle operated during fulfillment of the bid. The requestor media module 138 may be accessible during fulfillment of a bid as a requestor module 130 of the requestor component 102 and/or may interact with third party applications or devices. The requestor media module 138 may communicate media to the vehicle via FM modulation, Bluetooth streaming, physical connection, built-in speakers, or another connection interface that would be appreciated by a person of skill in the art after having the benefit of this disclosure.

The contractor component will now be discussed in more detail. The contractor component 104 may include features implemented in hardware and/or software. For example, the contractor component 104 may include a processor 140 and memory 142 capable of executing computer coded instructions. The contractor component 104 may additionally include an input/output (I/O) connection 146 to interface with additional components. Furthermore, the contractor component 104 may include a network communications interface 150, through which the features of the contractor component 104 may communicate with additional devices connected via a network 108.

The contractor component 104 may share some similarities with the requestor component 102 discussed above. In some embodiments, the contractor component 104 and the requestor component 102 may be operable using the same hardware components. In other embodiments, the contractor component 104 and requestor component 102 may have different hardware requirements and/or features, and thus would be operable on differing hardware devices.

The contractor component 104 may include contractor modules 160. The contractor modules 160 may operate via software commands, hardware-implemented logic, in association with sensors, using a combination of hardware and software features, and/or using additional features that would be apparent to a person of skill in the art after having the benefit of this disclosure.

The contractor modules 160 may sense, gather, report, and/or otherwise provide information usable to create a bid. This information may be stored in a database, which may be a local database via the contractor module and/or communicably connected database 192 accessible via a network 108. In one example, the database 192 may be included by a server 106 communicably accessible via the network 108.

A selection of illustrative contractor modules 160 will now be provided to demonstrate some features and capabilities of a contractor module. Information captured and/or provided by contractor modules 160 is storable locally by the individual module, by the contractor component 104, and/or in a connected database 192. In embodiments where at least part of the information is stored in a network accessible database 192, at least part of the information may be accessible via the network 108 to other connected devices of the system.

The contractor modules 160 may include a contractor profile module 161. An illustrative contractor profile module 161 may include information about a contractor. Possible information may include name, age, background information, automotive insurance coverage, employer affiliations, contractor status, trips completed, transaction history, rating, peers, and/or other information that could be used to describe the contractor. Skilled artisans will appreciate additional types of information that may be related to the contractor, and therefore may be included by the contractor profile module 161, after having the benefit of this disclosure.

The contractor modules 160 may include a contractor vehicle module 162. An illustrative contractor vehicle module 162 may include information about one or more vehicles operated by the contractor. Vehicles with information provided by the contractor vehicle module 162 may include vehicles owned by the contractor, frequently used by the contractor, and/or otherwise associated with the contractor. Vehicles included by the contractor vehicle module 162 may be a first vehicle. The contractor vehicle module 162 may include required dimensions, hook-up features, and/or other conditions of a second vehicle with which the first vehicle may be compatible. Details may be stored by the contractor vehicle module 162 relating to a first vehicle operated by the contractor, for example, make, model, year, interior volume requirement for storage of the first vehicle, accessibility considerations, source of mechanical propulsion, other mechanical information, maintenance information, insurance information, and/or other details that would be apparent to a skilled artisan after having the benefit of this disclosure. Additionally, details may be stored by the contractor vehicle module 162 relating to compatible second vehicles, for example, make, model, year, interior volume, storage capacity, accommodation for first vehicle, seats, articles present within the vehicle, accessibility considerations, mechanical information, maintenance information, insurance information, and/or other details that would be apparent to a skilled artisan after having the benefit of this disclosure.

The contractor modules 160 may include a contractor location module 163. An illustrative contractor location module 163 may include information about a contractor's current location, operational coverage area, acceptable destinations, user-defined location, location history, and other locations that may be useful in defining and/or acceptance of a bid. In one embodiment, the contractor location module 163 may use sensors and or other computerized components to assist in determining a location. Illustrative sensors may include global positioning sensors (GPS), antenna useful for triangulation of cellular or other wireless signals, internet access point or network recognition tools, and/or other location sensing features that would be apparent to a person of skill in the art after having the benefit of this disclosure.

The contractor modules 160 may include a contractor payment module 164. An illustrative contractor payment module 164 may include information regarding receiving payment for fulfillment of the bid. Examples of payment methods may include connections to a bank account, credit card, deposit account, reward points, gift points, credits, cash, other forms of currency, and/or other forms of payment or compensation that would be apparent to skilled artisans. Stored payment methods for a requestor associated with fulfillment of the bid may be retrieved via the contractor payment module 164 to automatically pay a contractor after completion of the bid. The contractor payment module 164 may additionally be used to pay access, usage, and/or other fees associable with using the system. Stored payment methods may also be optionally accessible to cover incidentals and/or damages incurred during fulfillment of the bid.

The contractor modules 160 may include a contractor trip module 165. An illustrative contractor trip module 165 may include information regarding compatibility with a trip requested via bid. For example, the contractor trip module 165 may include information about commonly accepted and/or fulfilled trips, such as a trip to requestors homes or other locations. In another example, a contractor trip module 165 may include information for recommended trips, such as to a late night restaurant or a suggested location of interest. Optionally, some locations of interest may be sponsored by third parties or advertisers. Recommended trip and sponsored content may be provided at least partially via a commercial module included with the system.

The contractor modules 160 may include a contractor bid browser module 166. An illustrative contractor bid browser module 166 may include tools to search and/or browse bids. The contractor bid browser module 166 may include a filter 167, which may remove or obscure bids that are incompatible, do not match a contractor's desired criteria, and/or otherwise do not meet the conditions of the filter 167. The filter 167 may optionally be used to highlight prospective bids of high interest, for example, bids with high earning potentials or favorable destinations.

The tools of the contractor bid browser module 166 may operate with other contractor modules 160 of the contractor component 104 to provide information of a bid. For example, the contractor bid browser module 166 may access information about current bids created by requestors. The contractor bid browser module 166 may analyze one more conditions associated with the bid with the contractor, for example via the contractor profile module 161, a first vehicle via the contractor vehicle module 162, and predictive trip via information provided by the contractor trip module 163. The information provided by contractor modules 160 may be used to suggest whether a contractor may meet conditions necessary for eligibility to accept a bid. In one embodiment, a contractor interface may be manipulated to browse eligible bids using the contractor bid browser module 166.

The information of various contractor modules 160 and other tools of the contractor bid browser module 166 may optionally be used in association with a filter 167. The filter 167 may advantageously allow the contractor to browse only bids that are compliant with one or more conditions. For example, the contractor may define his or her own conditions to sort or otherwise highlight preferable bids. In one embodiment, filter conditions and conditions associated with a bid may operate independently, cooperatively, discretely, or in another associative relationship that would be appreciated by skilled artisans.

The contractor modules 160 may optionally include a contractor recording module. An illustrative contractor recording module may permit recording of at least part a bid being fulfilled. The contractor recording module may operate with sensors and other aspects of the contractor component. For example, the contractor recording module may operate a camera and/or microphone connected to the contractor component 104 via its I/O connections 146. In an alternative embodiment, the contractor recording module may remotely operate a camera or other recording device communicably connected to the system.

Using the contractor recording module, the system may advantageously allow parties associated with fulfillment of a bid to record at least part of the fulfillment of the bid. For example, the contractor recording module may allow users to record a trip from start to end. In an illustrative application, provided in the interest of clarity and without limitation, cameras usable with the contractor recording module may be located on the contractor's device, uniform, clothing, or within the vehicle being operated by the contractor. Aspects of a recording could be selectively disabled, for example, to allow recording of video without sound, sound without video, or another combination of recorded information that would be apparent to a person of skill in the art.

The contractor modules 160 may include a contractor media module 168. An illustrative contractor media module 168 may allow a contractor and/or requestor to select a type of media for playback during fulfillment of a bid. For example, a requestor associated with the bid may interface the contractor media module 168 to select a song for playback through the speakers of the vehicle operated during fulfillment of the bid. In a specific example, provided without limitation, a requestor may select a song via a requestor media module 138 using his or her requestor component of the system. The requestor-selected song may be transmitted to the contractor media module of the contractor to play through the audio system of the connected vehicle. This example may be useful when the requestor is riding with the contractor in a first vehicle with a hook-up mechanism. The contractor media module 168 may be accessible via a contractor module 160 of the contractor component 104 and/or may interact with third party applications or devices. The contractor media module 168 may communicate media to the vehicle via FM modulation, Bluetooth streaming, physical connection, built-in speakers, or another connection interface that would be appreciated by a person of skill in the art after having the benefit of this disclosure.

An illustrative server 106 will now be discussed in more detail. The server 106 may include features implemented in hardware and software. For example, the server may include a processor 180 and memory 182 capable of executing computer coded instructions. The server 106 may additionally include an input/output (I/O) connection 186 to interface with additional components. Furthermore, the server 106 may include a network communications interface 190, through which the features of the server 106 may communicate with additional devices connected via a network 108. In some embodiments, the server 106 may include a database 192.

Those of skill in the art will appreciate the above illustrative system is provided in the interest of clarity, and is not intended to limit possible implementations of a driver contracting system in any way. Skilled artisans will appreciate additional embodiments that may include or exclude certain components that are within the scope and spirit of this disclosure.

Information used by the system may be stored in a database. Generally, a database is a collection of related information about a subject organized in a useful manner that provides a base or foundation for procedures, such as retrieving information, drawing conclusions, and making decisions. Information collected for these purposes may be provided by a database, even if the information is not stored on a computer. The information included by the database may be created, maintained, organized, and/or retrieved using a database management system, which may be included by the driver contractor system described in this disclosure.

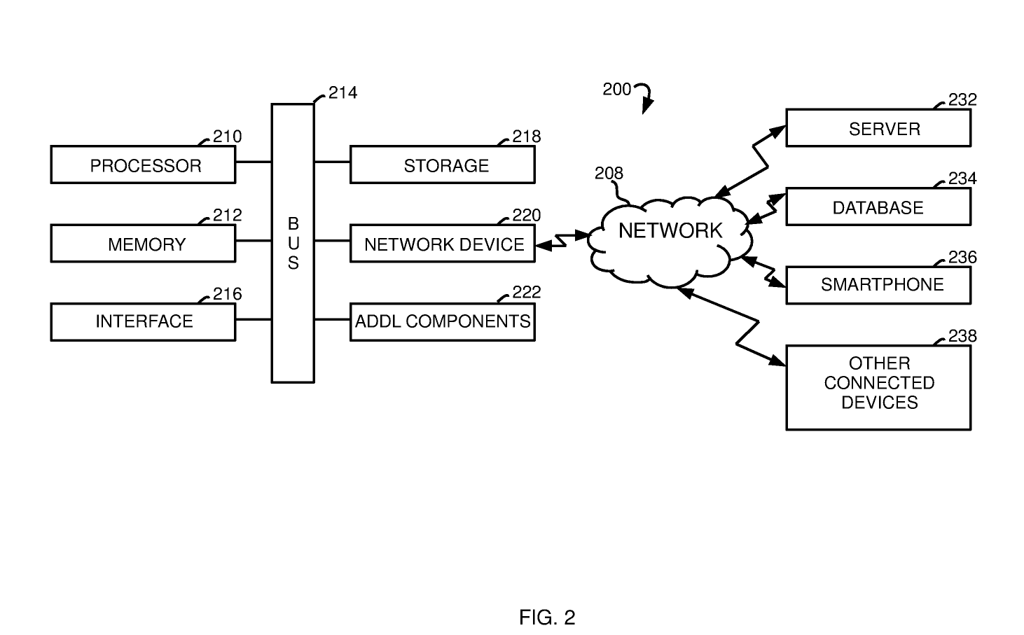

Referring now to FIG. 2, an illustrative computerized device will be discussed, without limitation. Various aspects and functions described in accord with the present disclosure may be implemented as hardware or software on one or more illustrative computerized devices 200 or other computerized devices. There are many examples of illustrative computerized devices 200 currently in use that may be suitable for implementing various aspects of the present disclosure. Some examples include, among others, network appliances, personal computers, workstations, mainframes, networked clients, servers, media servers, application servers, database servers and web servers. Other examples of illustrative computerized devices 200 may include mobile computing devices, cellular phones, smartphones, tablets, video game devices, personal digital assistants, network equipment, devices involved in commerce such as point of sale equipment and systems, such as handheld scanners, magnetic stripe readers, bar code scanners and their associated illustrative computerized device 200, among others. Additionally, aspects in accord with the present disclosure may be located on a single illustrative computerized device 200 or may be distributed among one or more illustrative computerized devices 200 connected to one or more communication networks.

For example, various aspects and functions may be distributed among one or more illustrative computerized devices 200 configured to provide a service to one or more client computers, or to perform an overall task as part of a distributed system. Additionally, aspects may be performed on a client-server or multi-tier system that includes components distributed among one or more server systems that perform various functions. Thus, the disclosure is not limited to executing on any particular system or group of systems. Further, aspects may be implemented in software, hardware or firmware, or any combination thereof. Thus, aspects in accord with the present disclosure may be implemented within methods, acts, systems, system elements and components using a variety of hardware and software configurations, and the disclosure is not limited to any particular distributed architecture, network, or communication protocol.

FIG. 2 shows a block diagram of an illustrative computerized device 200, in which various aspects and functions in accord with the present disclosure may be practiced. The illustrative computerized device 200 may include one or more illustrative computerized devices 200. The illustrative computerized devices 200 included by the illustrative computerized device may be interconnected by, and may exchange data through, a communication network 208. Data may be communicated via the illustrative computerized device using a wireless and/or wired network connection.

Network 208 may include any communication network through which illustrative computerized devices 200 may exchange data. To exchange data via network 208, systems and/or components of the illustrative computerized device 200 and the network 208 may use various methods, protocols and standards including, among others, Ethernet, Wi-Fi, Bluetooth, TCP/IP, UDP, HTTP, FTP, SNMP, SMS, MMS, SS7, JSON, XML, REST, SOAP, RMI, DCOM, and/or Web Services, without limitation. To ensure data transfer is secure, the systems and/or modules of the illustrative computerized device 200 may transmit data via the network 208 using a variety of security measures including TSL, SSL, or VPN, among other security techniques. The illustrative computerized device 200 may include any number of illustrative computerized devices 200 and/or components, which may be networked using virtually any medium and communication protocol or combination of protocols.

Various aspects and functions in accord with the present disclosure may be implemented as specialized hardware or software executing in one or more illustrative computerized devices 200, including an illustrative computerized device 200 shown in FIG. 2. As depicted, the illustrative computerized device 200 may include a processor 210, memory 212, a bus 214 or other internal communication system, an input/output (I/O) interface 216, a storage system 218, and/or a network communication device 220. Additional devices 222 may be selectively connected to the computerized device via the bus 214. Processor 210, which may include one or more microprocessors or other types of controllers, can perform a series of instructions that result in manipulated data. Processor 210 may be a commercially available processor such as an ARM, x86, Intel Core, Intel Pentium, Motorola PowerPC, SGI MIPS, Sun UltraSPARC, or Hewlett-Packard PA-RISC processor, but may be any type of processor or controller as many other processors and controllers are available. As shown, processor 210 may be connected to other system elements, including a memory 212, by bus 214.

The illustrative computerized device 200 may also include a network communication device 220. The network communication device 220 may receive data from other components of the computerized device to be communicated with servers 232, databases 234, smart phones 236, and/or other computerized devices 238 via a network 222. The communication of data may optionally be performed wirelessly. More specifically, without limitation, the network communication device 220 may communicate and relay information from one or more components of the illustrative computerized device 200, or other devices and/or components connected to the computerized device 200, to additional connected devices 232, 234, 236, and/or 238. Connected devices are intended to include, without limitation, data servers, additional computerized devices, mobile computing devices, smart phones, tablet computers, and other electronic devices that may communicate digitally with another device. In one example, the illustrative computerized device 200 may be used as a server to analyze and communicate data between connected devices.

The illustrative computerized device 200 may communicate with one or more connected devices via a communications network 208. The computerized device 200 may communicate over the network 208 by using its network communication device 220. More specifically, the network communication device 220 of the computerized device 200 may communicate with the network communication devices or network controllers of the connected devices. The network 208 may be, for example, the internet. As another example, the network 208 may be a WLAN. However, skilled artisans will appreciate additional networks to be included within the scope of this disclosure, such as intranets, local area networks, wide area networks, peer-to-peer networks, and various other network formats. Additionally, the illustrative computerized device 200 and/or connected devices 232, 234, 236, and/or 238 may communicate over the network 208 via a wired, wireless, or other connection, without limitation.

Memory 212 may be used for storing programs and/or data during operation of the illustrative computerized device 200. Thus, memory 212 may be a relatively high performance, volatile, random access memory such as a dynamic random access memory (DRAM) or static memory (SRAM). However, memory 212 may include any device for storing data, such as a disk drive or other non-volatile storage device. Various embodiments in accord with the present disclosure can organize memory 212 into particularized and, in some cases, unique structures to perform the aspects and functions of this disclosure.

Components of illustrative computerized device 200 may be coupled by an interconnection element such as bus 214. Bus 214 may include one or more physical busses (for example, busses between components that are integrated within a same machine), but may include any communication coupling between system elements including specialized or standard computing bus technologies such as USB, Thunderbolt, SATA, FireWire, IDE, SCSI, PCI and InfiniBand. Thus, bus 214 may enable communications (for example, data and instructions) to be exchanged between system components of the illustrative computerized device 200.

The illustrative computerized device 200 also may include one or more interface devices 216 such as input devices, output devices and combination input/output devices. Interface devices 216 may receive input or provide output. More particularly, output devices may render information for external presentation. Input devices may accept information from external sources. Examples of interface devices include, among others, keyboards, bar code scanners, mouse devices, trackballs, magnetic strip readers, microphones, touch screens, printing devices, display screens, speakers, network interface cards, etc. The interface devices 216 allow the illustrative computerized device 200 to exchange information and communicate with external entities, such as users and other systems.

Storage system 218 may include a computer readable and writeable nonvolatile storage medium in which instructions can be stored that define a program to be executed by the processor. Storage system 218 also may include information that is recorded, on or in, the medium, and this information may be processed by the program. More specifically, the information may be stored in one or more data structures specifically configured to conserve storage space or increase data exchange performance. The instructions may be persistently stored as encoded bits or signals, and the instructions may cause a processor to perform any of the functions described by the encoded bits or signals. The medium may, for example, be optical disk, magnetic disk or flash memory, among others. In operation, processor 210 or some other controller may cause data to be read from the nonvolatile recording medium into another memory, such as the memory 212, that allows for faster access to the information by the processor than does the storage medium included in the storage system 218. The memory may be located in storage system 218 or in memory 212. Processor 210 may manipulate the data within memory 212, and then copy the data to the medium associated with the storage system 218 after processing is completed. A variety of components may manage data movement between the medium and integrated circuit memory element and does not limit the disclosure. Further, the disclosure is not limited to a particular memory system or storage system.

Although the above described illustrative computerized device is shown by way of example as one type of illustrative computerized device upon which various aspects and functions in accord with the present disclosure may be practiced, aspects of the disclosure are not limited to being implemented on the illustrative computerized device 200 as shown in FIG. 2. Various aspects and functions in accord with the present disclosure may be practiced on one or more computers having a different architectures or components than that shown in FIG. 2. For instance, the illustrative computerized device 200 may include specially-programmed, special-purpose hardware, such as for example, an application-specific integrated circuit (ASIC) tailored to perform a particular operation disclosed in this example. While another embodiment may perform essentially the same function using several general-purpose computing devices running Windows, Linux, Unix, Android, iOS, MAC OS X, or other operating systems on the aforementioned processors and/or specialized computing devices running proprietary hardware and operating systems.

The illustrative computerized device 200 may include an operating system that manages at least a portion of the hardware elements included in illustrative computerized device 200. A processor or controller, such as processor 210, may execute an operating system which may be, among others, an operating system, one of the above mentioned operating systems, one of many Linux-based operating system distributions, a UNIX operating system, or another operating system that would be apparent to skilled artisans. Many other operating systems may be used, and embodiments are not limited to any particular operating system.

The processor and operating system may together define a computing platform for which application programs in high-level programming languages may be written. These component applications may be executable, intermediate (for example, C# or JAVA bytecode) or interpreted code which communicate over a communication network (for example, the Internet) using a communication protocol (for example, TCP/IP). Similarly, aspects in accord with the present disclosure may be implemented using an object-oriented programming language, such as JAVA, C, C++, C#, Python, PHP, Visual Basic .NET, JavaScript, Perl, Ruby, Delphi/Object Pascal, Visual Basic, Objective-C, Swift, MATLAB, PL/SQL, OpenEdge ABL, R, Fortran or other languages that would be apparent to skilled artisans. Other object-oriented programming languages may also be used. Alternatively, assembly, procedural, scripting, or logical programming languages may be used.

Additionally, various aspects and functions in accord with the present disclosure may be implemented in a non-programmed environment (for example, documents created in HTML5, HTML, XML, CSS, JavaScript, or other format that, when viewed in a window of a browser program, render aspects of a graphical-user interface or perform other functions). Further, various embodiments in accord with the present disclosure may be implemented as programmed or non-programmed elements, or any combination thereof. For example, a web page may be implemented using HTML while a data object called from within the web page may be written in C++. Thus, the disclosure is not limited to a specific programming language and any suitable programming language could also be used.

An illustrative computerized device included within an embodiment may perform functions outside the scope of the disclosure. For instance, aspects of the system may be implemented using an existing commercial product, such as, for example, Database Management Systems such as SQL Server available from Microsoft of Redmond, Wash., Oracle Database or MySQL from Oracle of Redwood City, Calif., or integration software such as WebSphere middleware from IBM of Armonk, N.Y.

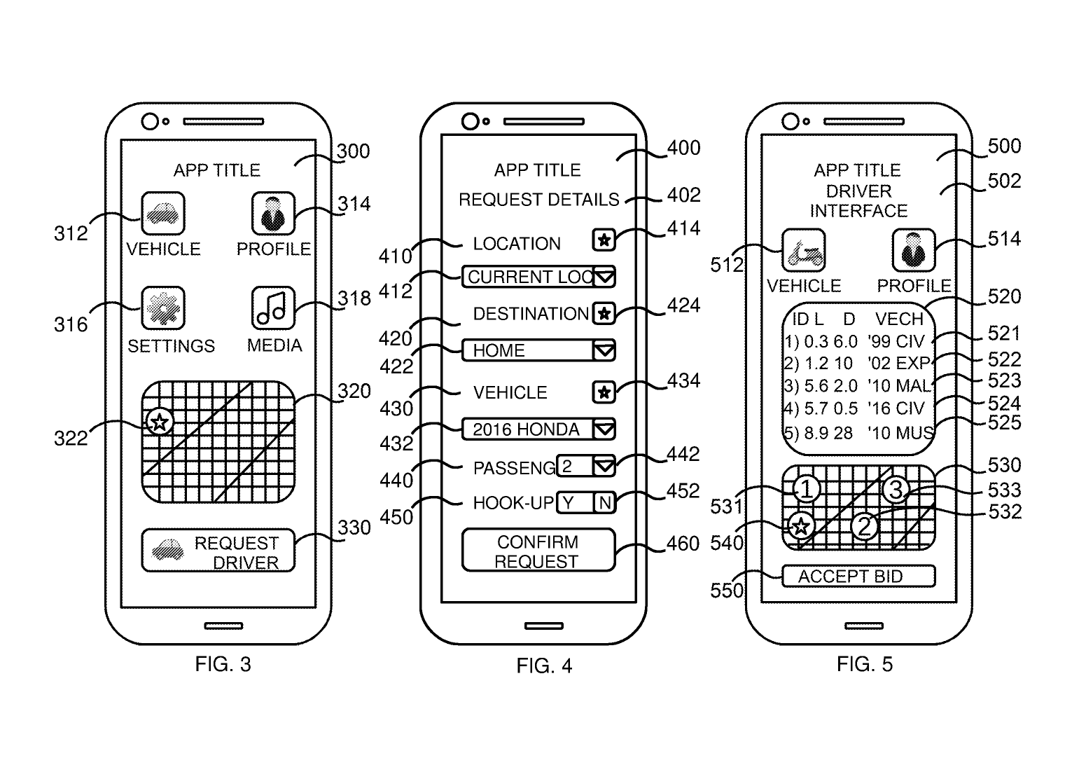

Referring to FIG. 3, an illustrative interface 300 for the requestor component will now be discussed, without limitation. The illustrative interface 300 of FIG. 3 may be displayed to a requestor accessing the driver contracting system of this disclosure. The requestor interface 300 may include interactive elements that can be operated to interact with the requestor component, including the requestor modules of the requestor component. Illustrative interactive components may include, without limitation, a requestor vehicle element 312, requestor profile element 314, requestor settings element 316, requestor media element 318, a requestor map element 320, and a requestor bid request element 330.

The illustrative requestor interface 300 may include a requestor vehicle element 312, which may direct a user to a vehicle subinterface. In one example, after engaging the requestor vehicle element 312, the requestor may define one or more vehicles for which a bid may be requested. The requestor interface 300, which may include a requestor vehicle subinterface accessible via the requestor vehicle element 312, may allow manipulation of the information provided by the requestor vehicle module of the requestor component.

The illustrative requestor interface 300 may include a requestor profile element 314, which may direct a user to a profile subinterface. In one example, after engaging the requestor profile element 314, the requestor may define one or more profiles for a bid requestor. The requestor interface 300, which may include a requestor profile subinterface accessible via the requestor profile element 314, may allow manipulation of the information provided by the requestor profile module of the requestor component.

The illustrative requestor interface 300 may include a requestor settings element 316, which may direct a user to a requestor settings subinterface. In one example, after engaging the requestor settings element 316, the requestor may define one or more settings for the requestor component and/or requestor modules. The requestor interface 300, which may include a requestor settings subinterface accessible via the requestor settings element 316, may allow manipulation of the information collected, provided, and/or the level of which such information is made accessible by the requestor modules of the requestor component.

The illustrative requestor interface 300 may include a requestor media element 318, which may direct a user to a media subinterface. In one example, after engaging the requestor media element 318, the requestor may select media to enjoy during fulfillment of a bid. The requestor interface 300, which may include a requestor media subinterface accessible via the requestor media element 318, may allow manipulation of the requestor media module and/or contractor media module.

The illustrative requestor interface 300 may include a requestor map element 320, which may provide a visual representation of the requestor's location 322 with respect to potential destinations. For example, a requestor could search using the requestor map element 320 to determine a destination, which may be included in a bid. In another embodiment, the requestor map element may display possible contractors within a vicinity of the requestor.

The illustrative requestor interface 300 may include a requestor bid request element 330, which may direct a user to a requestor bid request subinterface. An illustrative requestor bid request subinterface will be described in more detail along with FIG. 4. In one example, after engaging the requestor bid request element 330, the requestor may select parameters, conditions, and/or information to provide for a bid request. The requestor interface 300, which may include a requestor bid request subinterface accessible via the requestor bid request element 330, may allow manipulation of the requestor bid module and/or contractor bid module.

Referring to FIG. 4, an additional illustrative interface 400 for the requestor component will now be discussed, without limitation. The illustrative interface 400 of FIG. 4 may be displayed to a user, for example, a requestor, creating a bid. The illustrative interface 400 may include, without limitation, a requestor bid details interface title 402, a requestor bid location element 410, requestor bid destination element 420, requestor bid vehicle element 430, requestor bid passenger element 440, requestor bid hook-up element 450, and a requestor bid confirmation element 460.

The requestor bid location element 410 may be manipulated by a user to define a location at which the requested bid will originate. For example, where the bid is for transporting a requestor to a destination, the requestor bid location element 410 may define an origin. The requestor bid location element may be substantially automatically populated with common or listed location selecting an option from a requestor bid location selector 412. The options included by the requestor bid location selector 412 may be provided via the requestor location module of the requestor component. A requestor bid location shortcut 414 may be provided to substantially automatically define the location as the current location of the requestor. As discussed above, the current location of the requestor may be determined via the requestor location module, which may detect a location via various sensors of a connected electronic device such as the requestor component.

The requestor bid destination element 420 may be manipulated by a user to define a destination at which the requested bid will conclude. For example, where the bid is for transporting a requestor to a destination, the requestor bid destination element 420 may define a destination. The requestor bid destination element may be substantially automatically populated with common or listed destination selecting an option from a requestor bid destination selector 422. The options included by the requestor bid destination selector 422 may be provided via the requestor destination module of the requestor component. A requestor bid destination shortcut 424 may be provided to substantially automatically define the destination as the home destination of the requestor. As discussed above, the home destination of the requestor may be defined via the requestor profile module, requestor trip module, or other requestor modules, which may predict or suggest a likely destination.

The requestor bid vehicle element 430 may be manipulated by a user to define a vehicle associated with the requested bid. For example, where the bid is for transporting a requestor in his or her vehicle driven by a contractor, the requestor bid vehicle element 430 may define the requestor's vehicle. The requestor bid vehicle element may be substantially automatically populated with common or listed vehicle selecting an option from a requestor bid vehicle selector 432. The options included by the requestor bid vehicle selector 432 may be provided via the requestor vehicle module of the requestor component. A requestor bid vehicle shortcut 434 may be provided to substantially automatically define the vehicle as the primary vehicle of the requestor, which may have been previously defined by the requestor. As discussed above, the primary vehicle of the requestor may be defined via the requestor vehicle module, requestor profile module, or other requestor modules, which may predict or suggest a likely vehicle. In one embodiment, the second vehicle, as defined by the system, may be selected via the requestor bid vehicle element 430.

The requestor bid passenger element 440 may be manipulated by a user to define a number of passengers to be transported in association with the bid. The requestor bid passenger element 440 may be defined by selecting a quantity option from a requestor bid passenger selector 442. Additionally, a requestor bid hook-up element 450 may be manipulated by a user to select if a hook-up service, for example, a towing service, is requested with the bid. The requestor bid hook-up element 440 may be defined by selecting an option from a requestor bid hook-up selector 452.

Skilled artisans will appreciate additional information that may be included with a bid. Alternative embodiments of the interface 400 may include additional elements to define aspects of the bid, provide additional information, or otherwise provide a bid that may include information different from the above example. Such variations are intended to be included by the scope and spirit of this disclosure. Therefore, the above example is not intended to limit this disclosure in any way.

Once the requestor has entered substantially all the details desired to define the bid, the requestor may engage the requestor bid confirmation selector 460. Once the bid has been confirmed, the bid can be made viewable to, and acceptable by, contractors.

Referring to FIG. 5, an illustrative interface 500 for the contractor component will now be discussed, without limitation. The illustrative interface 500 of FIG. 5 may be displayed to a contractor accessing the driver contracting system of this disclosure. The contractor interface 500 may include a contractor interface title 502. The contractor interface 500 may also include interactive elements that can be operated to interact with the contractor component, including the contractor modules of the contractor component. Illustrative interactive components may include, without limitation, a contractor vehicle element 512, contractor profile element 514, contractor settings element, contractor media element, contractor bid browser element 520, contractor map element 530, and a contractor bid acceptance element 540.

The illustrative contractor interface 500 may include a contractor vehicle element 512, which may direct a user to a contractor vehicle subinterface. In one example, after engaging the contractor vehicle element 512, the contractor may define one or more vehicles for which a requested bid may be accepted. The contractor interface 500, which may include a contractor vehicle subinterface accessible via the contractor vehicle element 512, may allow manipulation of the information provided by the contractor vehicle module of the contractor component.

The illustrative contractor interface 500 may include a contractor profile element 514, which may direct a user to a contractor profile subinterface. In one example, after engaging the contractor profile element 514, the contractor may define or modify one or more profiles for a bid contractor. The contractor interface 500, which may include a contractor profile subinterface accessible via the contractor profile element 514, may allow manipulation of the information provided by the contractor profile module of the contractor component.

The illustrative contractor interface 500 may include a contractor bid browser element 520, which may provide a listing of potential bids that can be accepted by the contractor. The contractor bid browser element may display information provided by the contractor bid browser module of the contractor component. The bids displayed by the contractor bid browser element 520 may optionally be filtered via a filter of the contractor bid browser module.

In the interest of clarity, example bid entries 521-525 are provided to illustrate a possible bid listing viewable using the contractor bid browser element 520. The example bid entries 521-525 include a small selection of information that may be provided with a bid, and are not intended to limit the present disclosure in any way. Additional information may be provided with each bid, for example, by selecting a displayed summary of the bid. A contractor may view the information provided with the bid and determine whether the bid is compatible with the contractor's first vehicle and/or is desirable to accept.

A first example bid entry 521 describes a bid for a requestor approximately 0.3 miles from the contractor. The first example bid 521 requests to be transported by the contractor in the requestor's 1999 Honda Civic for a distance about 6 miles from the origin. A second example bid entry 522 describes a bid for a requestor approximately 1.2 miles from the contractor. The second example bid 522 requests to be transported by the contractor in the requestor's 2002 Ford Explorer for a distance about 10 miles from the origin. A third example bid entry 523 describes a bid for a requestor approximately 5.6 miles from the contractor. The third example bid 523 requests to be transported by the contractor in the requestor's 2010 Chevrolet Malibu for a distance about 2 miles from the origin. A fourth example bid entry 524 describes a bid for a requestor approximately 5.7 miles from the contractor. The fourth example bid 524 requests to be transported by the contractor in the requestor's 2016 Honda Civic for a distance about 0.5 miles from the origin. A fifth example bid entry 525 describes a bid for a requestor approximately 8.9 miles from the contractor. The fifth example bid 525 requests to be transported by the contractor in the requestor's 2010 Ford Mustang for a distance about 28 miles from the origin.

The illustrative contractor interface 500 may include a contractor map element 530, which may provide a visual view of potential bids 531-533 in the vicinity of the contractor. In this example, marker 531 may indicate a location for bid 521, marker 532 may indicate a location for bid 522, and marker 533 may indicate a location for bid 523. The contractor map element 530 may additionally provide a visual representation of the contractor's location 540 with respect to potential bids. For example, a contractor could search using the contractor map element 530 to determine a bid for potential acceptance.

The illustrative contractor interface 500 may include a contractor bid acceptance element 550, which may allow a contractor to provisionally accept a selected bid. In one example, after engaging the contractor bid acceptance element 550, the contractor may reserve acceptance for the bid request. An another embodiment, a bid can be affirmatively accepted via the contractor interface 500, for example, using the contractor bid acceptance element 550.

The system and method provided by this disclosure may operate using a first vehicle and a second vehicle. Generally, the first vehicle will be associated with a contractor and the second vehicle will be associated with a requestor. The first vehicle and/or second vehicle may include features to permit interaction between the first and second vehicles.

The first vehicle will now be discussed in greater detail. The first vehicle may be used primarily to transport the contractor among various locations. For example, the first vehicle may be used to transport the contractor to a requestor during the acceptance of a bid. The first vehicle may also be associated with the second vehicle during fulfillment of a bid. For example, the location of the first vehicle may be changed along with the second vehicle by the contractor during fulfillment of a bid.

In one embodiment, the first vehicle may be a compact vehicle storable in or with the second vehicle. For example, without limitation, the first vehicle may be a compact motorbike with two or more wheels storable in the trunk, truck bed, or back seat of most vehicles. The first vehicle may include features required for street-legal operation, the requirements for which may vary from jurisdiction to jurisdiction. In this embodiment, the contractor may transport the requestor and the second vehicle through operation of the second vehicle, without limitation.

The first vehicle may include a motorized source of propulsion. Examples of a motorized source of propulsion may include an electric motor, internal combustion engine, hybrid engine, fuel cell engine, or other form of motorized combustion that would be appreciated by a person of skill in the art after having the benefit of this disclosure. The motorized source of propulsion may drive one or more wheels via a direct drive, transmission, chain, drive shaft, torque converter, or other component that would be appreciated by a person of skill in the art after having the benefit of this disclosure.

The first vehicle may include a substantially sealable fuel storage device. The fuel storage device may be accessed to recharge or refill the fuel used by the motorized source of propulsion. In one embodiment, the fuel storage device may be a fuel tank. In this embodiment, the fuel tank may be substantially storable with a reversibly sealable access aperture. In another embodiment, the fuel storage device may be an electrical charge storage device. For example, the fuel storage device may be a capacitor, battery, and/or other device capable of storing an electrical charge that would be appreciated by a person of skill in the art after having the benefit of this disclosure.

In one example, the first vehicle may be at least partially collapsible such to facilitate storage in smaller spaces. For example, at least part of the first vehicle may be foldable to reduce the volume required to store the first vehicle within the second vehicle. The seat of the first vehicle may be collapsed closer to the body of the vehicle. The handlebars and headlamp of the vehicle may be removed or collapsed closer to the body of the vehicle. Other aspects of the first vehicle that would be appreciated by a skilled artisan may additionally be collapsed, folded, or otherwise compacted, without limitation. The first vehicle may be initially stored in an at least partially sealed bag or container before being located within a second vehicle.

In another example, the first vehicle may be included with an attachment mechanism such that the first vehicle may be attached to an exterior portion of the second vehicle. For example, the first vehicle may be connected to the second vehicle via a tow hitch or other similar attachment interface. In another example, the first vehicle may be connected to the second vehicle via a temporary or removable rack or carrier, such as a roof rack, trunk rack, spare tire rack, and/or other rack that would be appreciated by a person of skill in the art after having the benefit of this disclosure.

In an alternative embodiment, the first vehicle may include a hook-up mechanism configured to hook-up to the second vehicle and relocate the second vehicle to the destination. The hook-up mechanism may include a boom, hook and chain, wheel-lift, spectacle-lift, flatbed, winch, integrated lift, and/or other hook-up mechanism that would be appreciated by a person of skill in the art after having the benefit of this disclosure.

In this embodiment, once the first vehicle with the hook-up mechanism is connected to the second vehicle, the contractor may transport the requestor and the second vehicle through operation of the first vehicle, without limitation. For example, the second vehicle may be transported passively by the first vehicle using the hook-up mechanism. A safety triangle and/or other signage may be located on the second vehicle during fulfillment of the bid.

The second vehicle will now be discussed in greater detail. The second vehicle may be an automobile or other vehicle owned or otherwise operated by the requestor. For example, the second vehicle may be the requestor's car. In one example, the contractor may travel to the requestor via the first vehicle, confirm acceptance of the bid, place the first vehicle within a suitable volume of the second vehicle, and transport the requestor and the first vehicle via the second vehicle, without limitation.

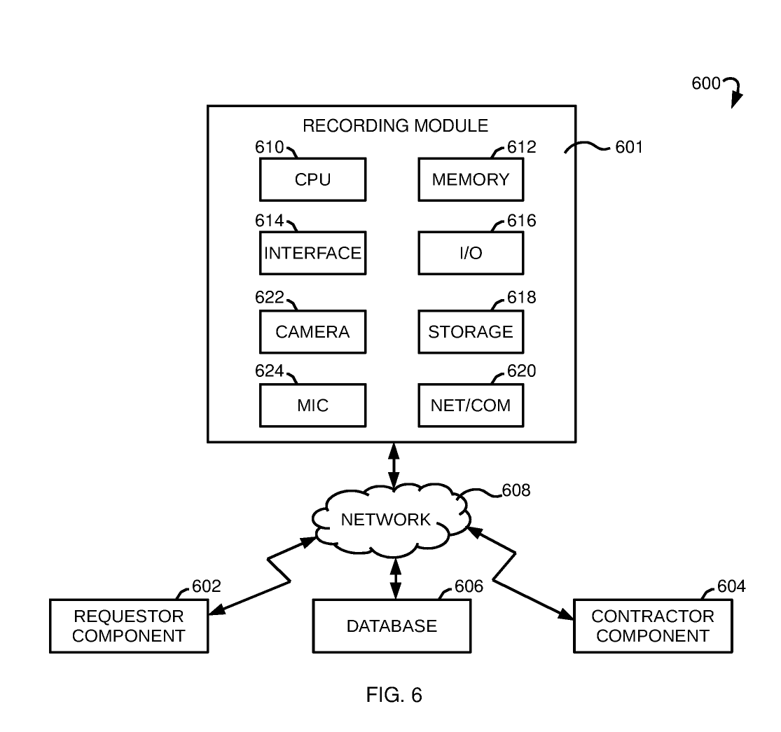

Referring to block diagram 600 of FIG. 6, an illustrative recording module will now be discussed, without limitation. With the recording module 601, the system advantageously gives a user an option to record substantially an entire trip or other fulfillment of a bid, for example, from start to end. A camera may be located on or otherwise communicably connected to a device operating the contractor module, without limitation. Alternative locations for the camera may include in a contractor uniform, a temporary location within a vehicle, and/or another location that would be appreciated by a person of skill in the art after having the benefit of this disclosure. The recording module and connected hardware may be selectively disabled, for example, if a requestor is uncomfortable being recorded.

The recording module 601 may permit recording of at least part a bid being fulfilled. The recording module 601 may operate with sensors and other devices capable of detecting a condition of an environment. A recording module 601 may be communicably connected to a requestor component 602, contractor component 604, and/or database 606 via a network 608. Alternatively, a recording module 601 may be included locally by a requestor component 602, contractor component 604, and/or database 606.

A recording module 601 may include features implemented in hardware and software. For example, the recording module 601 may include a processor 610 and memory 612 capable of executing computer coded instructions. The recording module 601 may additionally include an interface 614, which may be accessible via another interface of the system, such as the requestor interface, contractor interface, and/or other interface. Storage 618 may be included by the recording module 601 to store recorded audio, video, or other data. In one embodiment, data recorded by the recording module 601 may be at least partially stored on a database 606, which may be connected via the network 608.

The recording module 601 may additionally include an input/output (I/O) connection 616 to interface with additional components. Furthermore, the recording module 601 may include a network communications interface 620, through which the features of the recording module 601 may communicate with additional devices accessible via a network 608.

The recording module 601 may include a camera 622 and/or microphone 624 to record a condition of the environment. In an alternative embodiment, the recording module 601 may remotely operate a camera 622, microphone 624, and/or other recording device communicably connected to the system. Additionally, the recording module 601 may operate a camera 622 and/or microphone 624 connected to the its I/O connections 616.

Referring additionally to FIGS. 1 and 6, the recording module 601 may permit recording of at least part of a bid being fulfilled. The requestor recording module 137 may operate with sensors and other aspects of the requestor component. For example, the requestor recording module 137 may operate a camera and/or microphone connected to the requestor component 102 via its I/O connections 116. In an alternative embodiment, the requestor recording module 137 may remotely operate a camera or other recording device communicably connected to the system.

Using the requestor recording module 137, the system may advantageously allow parties associated with fulfillment of a bid to record at least part of the fulfillment of the bid. For example, the requestor recording module 137 may allow users to record a trip from start to end. In an illustrative application, provided in the interest of clarity and without limitation, cameras usable with the requestor recording module 137 may be located on the contractor's device, uniform, clothing, or within the vehicle being operated by the contractor. Aspects of a recording could be selectively disabled, for example, to allow recording of video without sound, sound without video, or another combination of recorded information that would be apparent to a person of skill in the art.

A dimension validation module will now be discussed in greater detail. The dimension validation module may compare at least part of the information relating to the first vehicle with at least part of the information relating to the second vehicle to determine a likelihood of compatibility. For example, the dimension validation module may access information provided by the requestor vehicle module. The requested information may be associated with a requestor profile, and may be stored in a database accessible via a network, on a device operating the requestor module, or in another location that would be appreciated by a person of skill in the art after having the benefit of this disclosure. An index of car makes, models, years, and corresponding back seat and cargo space measurements may be included by the database and accessible via the system. In one embodiment, the dimension validation may provide a warning and/or caution if a probable incompatibility is detected. In another embodiment, the dimension validation module may prohibit acceptance of a bid upon detecting a likely incompatibility.

A pricing module will now be discussed in greater detail. The pricing module may calculate an anticipated price for fulfillment of a bid. The pricing module may analyze various factors and/or conditions in determining an estimated price. For example, the pricing module may analyze information relating to a bid such as number of passengers, distance from origin to destination, inconvenience of a return trip, initial travel for the contractor to the requestor, demand, and other factors that would be appreciated by skilled artisans.

The pricing module may allow at least some flexibility, providing for the final price to fulfill a bid to vary from the anticipated price. For example, the final price may differ from the anticipated price due to unspecified extra passengers, misrepresented space to accommodate a first vehicle, misrepresented attachment mechanism to permit a hook-up, demand, change in demand, discount, reward, harassment, alternative route, passenger request, and other conditions that would be appreciated by a person of skill in the art after having the benefit of this disclosure. Pricing variation may occur with respect to demand. For example, demand may be affected by morning rush, evening rush, night rush, festivals, sports events, manifestations, weather conditions, geographic density of requests, and/or other conditions that would be appreciated by a skilled artisan.

Payment may be made by the requestor for fulfillment of the bid via commonly accepted payment methods. For example, payment may be made via cash, credit card, check, debit, gift card, credits, promotion, voucher, points, special denomination, and/or other payment method that would be appreciated by skilled artisans. The payment transaction may be processed via the requestor module, contractor module, in person, and/or other payment processing technique.

Contractors may be compensated for using the system via a payment schedule. At least a portion of the actual price paid by the requestor for fulfillment of the bid may be retained by an operator of the system. Additionally, a least a portion of the payment may be provided to the contractor as payment for accepting and/or completing a bid. The contractors may be paid by an operator of the system as an employee, independent contractor, affiliate, agent, or other permissible relationship between parties. Payment structures may include, without limitation, hourly, salary, per-mile during bid fulfillment, per-mile total, per-mile “empty,” per-mile other, per-bid, a combination of payment structures, and/or other payment structures that would be appreciated by a person of skill in the art after having the benefit of this disclosure.

In operation, the system may facilitate bidding for and engaging in a contract between a requestor and a contractor. In one embodiment, the contract may relate to providing transportation for a requestor and his or her vehicle. Those of skill in the art will appreciate that the following methods are provided to illustrate an embodiment of the disclosure, and should not be viewed as limiting the disclosure to only those methods or aspects. Skilled artisans will appreciate additional methods within the scope and spirit of the disclosure for performing the operations provided by the examples below after having the benefit of this disclosure. Such additional methods are intended to be included by this disclosure.

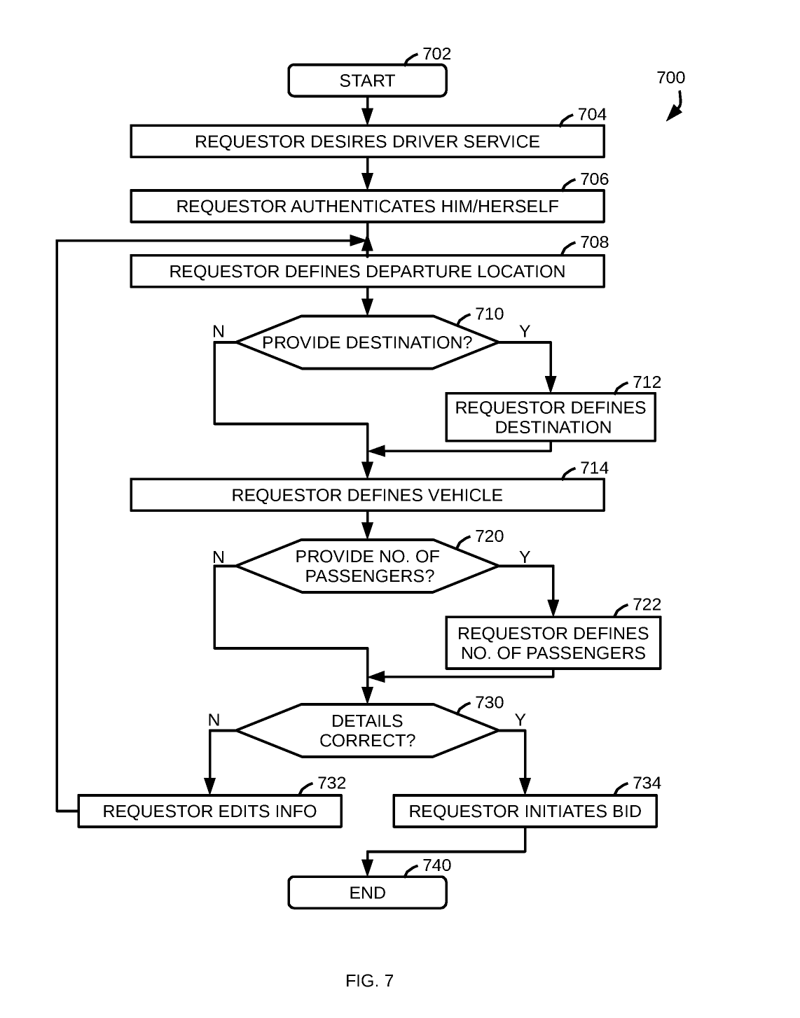

Referring now to the flowcharts FIGS. 7-11, various aspects of an illustrative operation to facilitate contracting between parties for driver services will now be described. These illustrative operations are provided in the interest of clarity, and to enable a person of skill in the art to practice the subject matter of this disclosure. The illustrative operations provided below are not intended to limit the scope of this disclosure in any way. Alternative embodiments of operations consistent with this disclosure are intended to be included within the scope and spirit of the disclosure and are not intended to be read against this disclosure.

Referring now to FIG. 7, flowchart 700 provides an illustrative operation of a requestor creating a bid, according to an embodiment of this disclosure. Starting at block 702, the requestor may desire to initiate a driver service (block 704). The requestor may authenticate himself or herself via a requestor component of the system (block 706). The requestor may then define his or her desired location from which a bid may originate (block 708). The requestor may determine whether to also provide a destination location at block 710. In some embodiments, the system may substantially automatically determine whether a destination location is required at block 710.

If it is determined at block 710 that a destination location will be provided, the requestor may provide the destination location (block 712). After the destination location has been provided at block 712, the operation may continue to block 714, where the requestor may define his or her vehicle associated with the bid. Additionally, if it is determined at block 710 that no destination information will be provided, the operation may also continue to block 714, where the requestor may define his or her vehicle associated with the bid. The requestor may determine whether to define a number of passengers to be transported in fulfillment of the bid at block 720.

If it is determined at block 720 that a number of passengers will be provided, the requestor may provide the passenger information (block 722). After the passenger information has been provided at block 722, the operation may continue to block 730, where the requestor may confirm that the information provided is correct. Additionally, if it is determined at block 720 that no passenger information will be provided, the operation may also continue to block 730, where the requestor may confirm that the information provided with the bid is correct.

If it is determined at block 730 that the information provided with the bid is not correct, the requestor may edit the provided information (block 732), for example, by editing the departure location at block 708. If it is determined at block 730 that the information provided with the bid is correct, the requestor may initiate the bid (block 734). The operation of the requestor requesting service may then terminate at block 740.

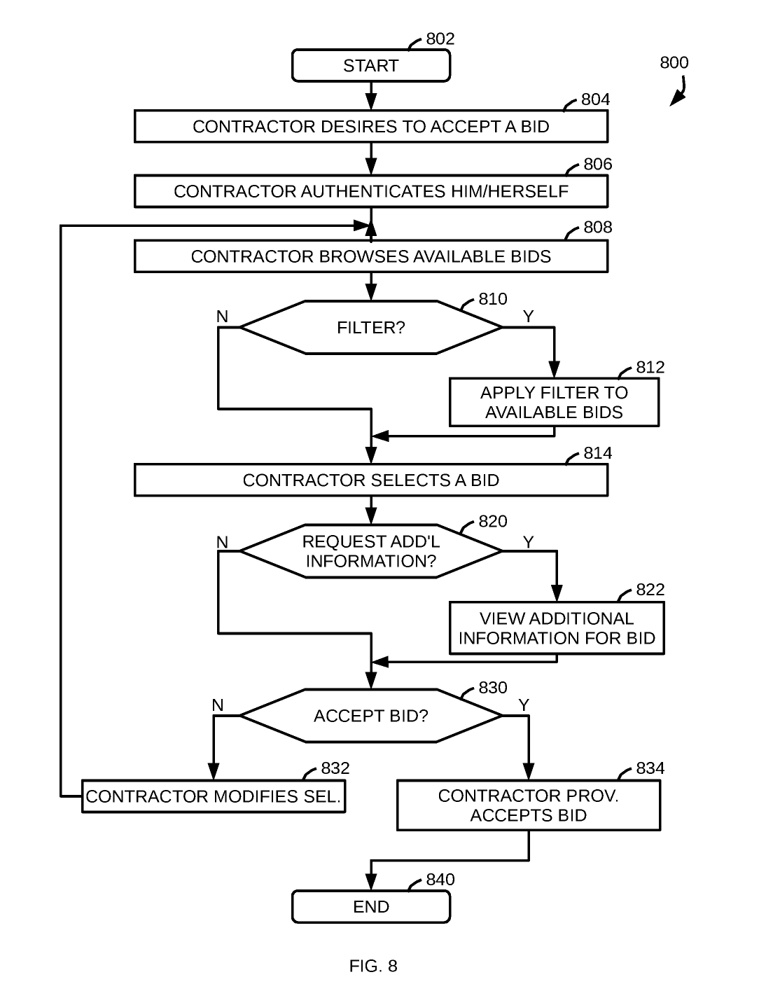

Referring now to FIG. 8, flowchart 800 provides an illustrative operation of a contractor provisionally accepting a bid, according to an embodiment of this disclosure. Starting at block 802, a contractor desiring to accept a bid may access the system (block 804). The contractor may authenticate himself or herself via a contractor component of the system (block 806). The contractor may interact with the contractor component to browse available bids (block 808). The contractor may determine whether to filter the available bids at block 810. The filter may set conditions, analyze the bids for compliance with the conditions, and at least partially exclude bids not in compliance with the conditions.

If it is determined at block 810 that the contractor chooses to filter the available bids, the contractor may apply a filter to the available bids via the contractor interface (block 812). After a filter has been applied at block 812, the operation may continue with the contractor selecting a bid for acceptance (block 814). If it is determined at block 810 that the contractor does not choose to filter the available bids, the operation may also continue with the contractor selecting a bid for acceptance at block 814.

If the contractor locates a bid of interest, the contractor may decide whether to request additional information from the system at block 820. If additional information about the bid is requested at block 820, the contractor may view the additional information for the bid (block 822). After the contractor finishes viewing the additional information at block 822, the contractor may decide whether to accept the bid at block 830. If additional information about the bid is not requested at block 820, the contractor may also decide whether to accept the bid at block 830 without viewing the additional information.

If the contractor determines not to accept the bid at block 830, the contractor may modify his or her selection at block 832, after which the contractor may return to browse additional bids via the contractor component of the system (block 808). If the contractor determines to accept the bid at block 830, the contractor may provisionally accept the bid at block 834. After the contractor has provisionally accepted a bid at block 834, the operation of a contractor viewing and potentially accepting a bid may terminate at block 840.

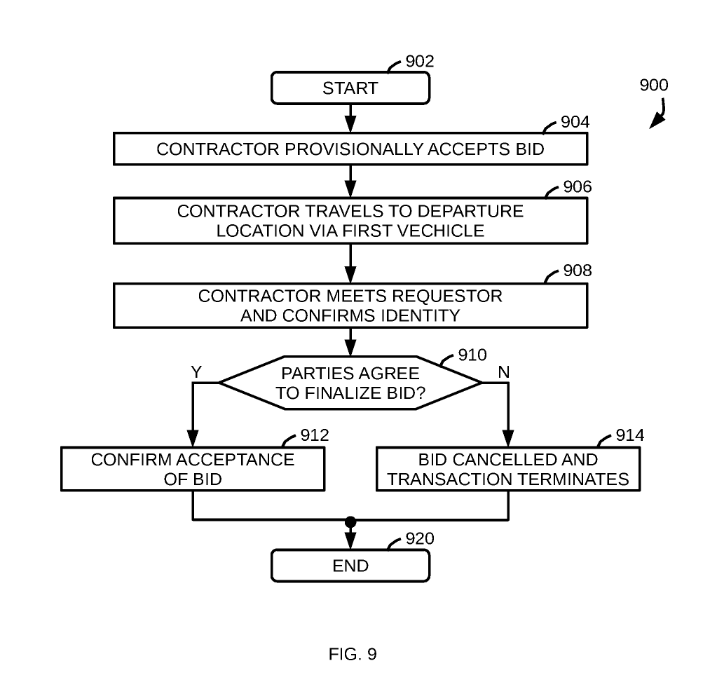

Referring now to FIG. 9, flowchart 900 provides an illustrative operation of a contractor traveling to a requestor to fulfill the bid, according to an embodiment of this disclosure. Starting at block 902, a contractor may provisionally accept a bid (block 904). The contractor may then travel to the departure location, which may be defined by the bid, via the first vehicle (block 906). The contractor may meet the requestor and confirm the identity of the requestor prior to finalizing the bid (block 908). Identity may be confirmed, for example, via an electronic handshake between devices operating the requestor component and/or the contractor component of the system, without limitation.

It may be determined at block 910 whether the parties agree to finalize the bid. If the parties decline to finalize the bid at block 910, the bid becomes cancelled and the transaction may terminate (block 912). In some embodiments, a cancellation fee may be imposed if one or more conditions of unacceptable cancellation are met. Alternatively, if the parties agree to acceptance of the bid at block 910, the bid may be finalized (block 914). Whether the bid is rejected at block 912 or finalized at block 914, the operation may terminate at block 920 after the determination of the provisionally accepted bid has been made.

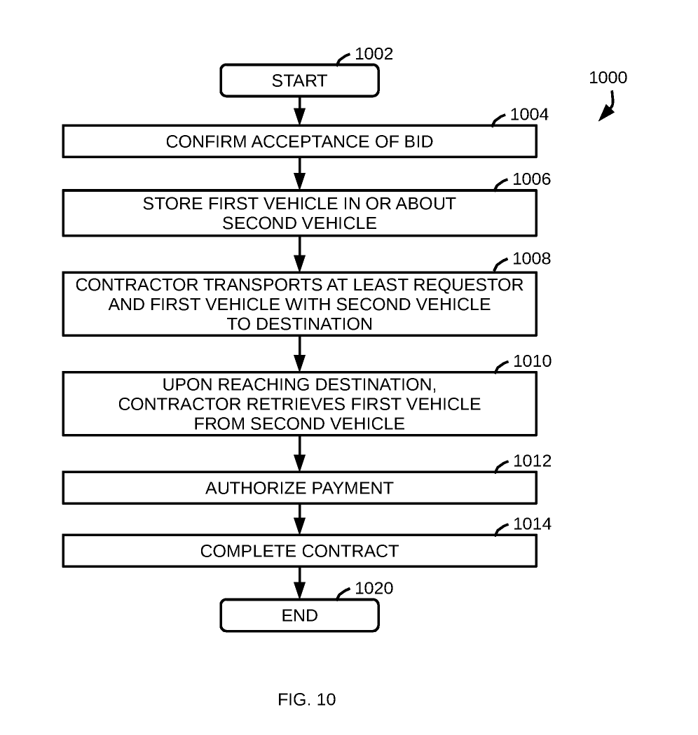

Referring now to FIG. 10, flowchart 1000 provides an illustrative operation of storing a first vehicle at least partially with a second vehicle, according to an embodiment of this disclosure. Starting at block 1002, the contractor and the requestor may confirm acceptance of the bid (block 1004). The contractor may then store the first vehicle in or about the second vehicle (block 1006). For example, the contractor may locate the first vehicle in the trunk of the second vehicle. In another example, the first vehicle may be attached to an exterior location of the second vehicle via a tow hitch, rack, or other attachment device that would be appreciated by a skilled artisan.

The contractor may transport at least the requestor and the first vehicle with the second vehicle to the destination (block 1008). For example, the contractor may transport additional passengers during fulfillment of the bid, without limitation. Upon reaching the destination, the contractor may retrieve the first vehicle from the second vehicle (block 1010). The requestor may then authorize payment for fulfilling the bid (block 1012). Alternatively, payment may be substantially automatically withdrawn from the requestor's account upon fulfillment of the bid. Once payment has been made, the bid may be fulfilled, completing the contract (block 1014). The operation of fulfilling the bid may then terminate at block 1020.

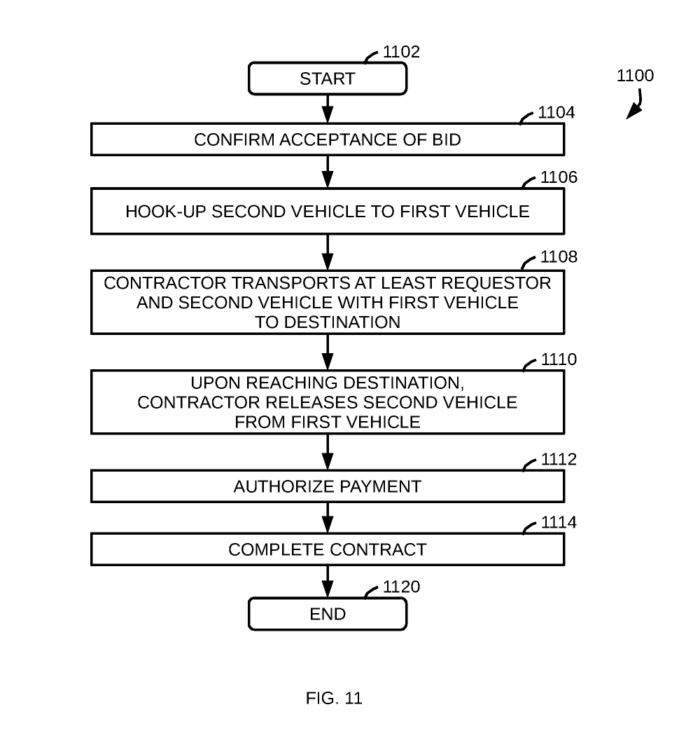

Referring now to FIG. 11, flowchart 1100 provides an illustrative operation of an alternative embodiment including use of a hook-up mechanism, according to an embodiment of this disclosure. Starting at block 1102, the contractor and the requestor may confirm acceptance of the bid (block 1104). The contractor may then hook-up the second vehicle to the first vehicle, for example, via a hook-up mechanism (block 1106).

The contractor may transport at least the requestor and the second vehicle with the first vehicle to the destination (block 1108). In one embodiment, the second vehicle may be passively transported by the first vehicle to the destination. Additionally, the contractor may transport additional passengers during fulfillment of the bid, for example in the first vehicle, without limitation. Upon reaching the destination, the contractor may release the second vehicle from the hook-up mechanism of the first vehicle (block 1110). The requestor may then authorize payment for fulfilling the bid (block 1112). Alternatively, payment may be substantially automatically withdrawn from the requestor's account upon fulfillment of the bid. Once payment has been made, the bid may be fulfilled, completing the contract (block 1114). The operation of fulfilling the bid may then terminate at block 1120.

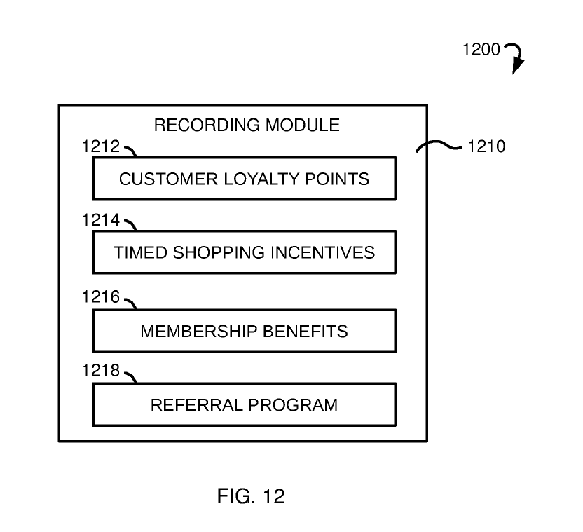

Referring to block diagram 1200 of FIG. 12, a commercial platform module 1210 will now be discussed. The commercial platform module may include a customer loyalty point aspect 1212, timed shopping incentives aspect 1214, membership benefits 1216, and/or a referral program aspect 1218.

The customer loyalty point aspect 1212 may include use of a loyalty account, points account, reward account, advantage account, or other account that can provide rewards for continued use of the system. For example, a customer loyalty points aspect may reward a requestor with credit for future use of the system as the requestor requests, completes, and pays for fulfillment of bids, without limitation.

The commercial platform module may additionally include a time shopping incentives aspect 1214, which may provide time-limited discounts and/or promotions for incentivize shopping while in fulfillment of a bid. For example, the time shopping incentives aspect may display a shopping interface via the requestor component of the system, through which the requestor may shop while waiting for the contractor to arrive and/or while being transported by the contractor. The timed shopping incentives aspect may provide special discounts available only while in transit during fulfillment. Additional incentives that could be provided by the time shopping incentives aspect would be appreciated by a person of skill in the art after having the benefit of this disclosure.

The membership benefits 1216 of the commercial platform module may provide additional benefits to members of the system. For example, membership may include a priority or VIP level, offering an increased likelihood that the VIP bid will be accepted above non-VIP members. Additional member benefits may include exclusive discounts, additional features, and other benefits that would be appreciated by a skilled artisan.

The referral program aspect 1218 of the commercial platform module may provide incentives and/or rewards for referring additional potential users to engage the system. The referral program aspect may advantageously warm new requestors and/or contractors into the system through the recommendation of their peers.

While various aspects of an invention have been described in the above disclosure, the description of this disclosure is intended to illustrate and not limit the scope of the invention. The invention is defined by the scope of the appended claims and not the illustrations and examples provided in the above disclosure. Skilled artisans will appreciate additional aspects of the invention, which may be realized in alternative embodiments, after having the benefit of the above disclosure. Other aspects, advantages, embodiments, and modifications are within the scope of the following claims.

What is claimed is:

1. A system operable on a computerized device with a processor and memory comprising:
a database accessible via a network comprising information for a bid, a requestor, and a contractor, the bid being creatable by the requestor and the bid being selectively accepted by the contractor;
a requestor component communicably connected to the database through which the bid is created, comprising requestor modules to provide at least part of the information associated with the bid;
a contractor component communicably connected to the database through which the bid is acceptable, comprising contractor modules to access the at least part of the information by the contractor associated with the bid;
wherein the bid is accepted via the steps:
a) communicating the bid to the database by the requestor for acceptance by the contractor, the bid comprising the at least part of the information provided by the at least part of the requestor modules,
b) viewing the bid by the contractor,
c) provisionally accepting the bid by the contractor,
d) traveling by the contractor to the requestor via a first vehicle,
e) transporting the requestor, the first vehicle, and a second vehicle associated with the requestor to a destination by the contractor, and
f) fulfilling the bid to receive payment.

2. The system of claim 1, wherein the first vehicle is storable at least partially within the second vehicle for transportation by the contractor.

3. The system of claim 1, wherein the first vehicle comprises at least two wheels, and wherein at least one of the wheels is driven by a motorized source of propulsion.

4. The system of claim 1, wherein the first vehicle is at least partially collapsible.

5. The system of claim 1, wherein the bid comprises a condition, the bid being acceptable only by the contractor meeting the condition.

6. The system of claim 5, wherein the first vehicle comprises a hook-up mechanism, wherein transporting the second vehicle comprises reversibly hooking up to the first vehicle via the hook-up mechanism, and wherein the bid comprises an indication that having a hook-up mechanism is comprised by the condition.

7. The system of claim 6, wherein the second vehicle is passively transported via the hook-up mechanism of the first vehicle to the destination.

8. The system of claim 1, wherein the requestor modules comprise a media module through which media is selectable to be played as at least part of the bid is fulfilled.

9. The system of claim 1, further comprising a recorder module capable of recording at least part of the bid being fulfilled.

10. The system of claim 1, wherein the contractor component comprises an interface with a map, and wherein the bid is acceptable from the interface.

11. The system of claim 1, wherein the bid comprises the destination, and wherein the destination is included in the information viewable to the contractor.

12. The system of claim 1, further comprising a commercial platform through which the requestor can perform commercial transactions associated with fulfillment of the bid, the commercial transactions performed through the commercial platform being at least partially monetized by the system.

13. The system of claim 1, wherein the database is storable on a server accessible by at least the requestor component and the contractor component via the network.

14. A system operable on a computerized device with a processor and memory comprising:
a database accessible via a network comprising information for a bid, a requestor, and a contractor, the bid being creatable by the requestor and the bid being selectively accepted by the contractor;
a requestor component communicably connected to the database through which the bid is created, comprising requestor modules to provide at least part of the information associated with the bid;
a contractor component communicably connected to the database through which the bid is acceptable, comprising contractor modules to access the at least part of the information associated with the bid by the contractor;
wherein the bid is accepted via the steps:
a) communicating the bid to the database by the requestor for acceptance by the contractor, the bid comprising the at least part of the information provided by the at least part of the requestor modules,
b) viewing the bid by the contractor,
c) provisionally accepting the bid by the contractor,
d) traveling by the contractor to the requestor via a first vehicle,
e) storing the first vehicle at least partially within a second vehicle associated with the requestor,
f) transporting the requestor, the first vehicle, and the second vehicle to a destination by the contractor,
g) removing the first vehicle from the second vehicle, and
h) fulfilling the bid;
wherein the bid comprises a condition, the bid being acceptable only by the contractor meeting the condition.

15. The system of claim 14, wherein the first vehicle is at least partially collapsible.

16. The system of claim 14, further comprising:
a media module through which media is selectable to be played via the second vehicle as at least part of the bid is fulfilled;
a recorder module capable of recording at least part of the bid being fulfilled; and
a commercial platform through which the requestor can perform commercial transactions associated with fulfillment of the bid, the commercial transactions performed through the commercial platform being at least partially monetized by the system.

17. A method for matching a requestor with a contractor via a system comprising a processor and memory, the method comprising the steps:
a) communicating a bid by the requestor to a database via a requestor component for acceptance by the contractor, the database being accessible via a network and comprising information for the bid, the requestor, and the contractor;
b) viewing the bid by the contractor via a contractor component, the bid comprising at least part of the information provided by the requestor;
c) provisionally accepting the bid by the contractor via the contractor component;
d) traveling by the contractor to the requestor via a first vehicle;
e) transporting the requestor, the first vehicle, and a second vehicle associated with the requestor to a destination by the contractor; and
f) fulfilling the bid to receive payment;
wherein the bid is creatable by the requestor, the bid comprising a condition;
wherein the bid is selectively accepted by the contractor meeting the condition;
wherein the requestor component and the contractor component are communicably connected to the database;
wherein the requestor component comprises requestor modules to provide at least part of the information associated with the bid;
wherein the contractor component comprises contractor modules to access the at least part of the information associated with the bid by the contractor.

18. The method of claim 17, further comprising after step (d), step (g) storing the first vehicle at least partially within the second vehicle; and comprising after step (e), step (h) removing the first vehicle from the second vehicle.

19. The method of claim 17, further comprising after step (d), step (i) reversibly connecting the second vehicle to a hook-up mechanism of the first vehicle; and
comprising after step (e), step (j) disconnecting the second vehicle from the hook-up mechanism.

20. The method of claim 17, wherein the system comprises:
a media module through which media is selectable to be played as at least part of the bid is fulfilled;
a recorder module capable of recording at least part of the bid being fulfilled; and
a commercial platform through which the requestor can perform commercial transactions associated with fulfillment of the bid, the commercial transactions performed through the commercial platform being at least partially monetized by the system.
